(19) United States
(12) Patent Application Publication
(10) Pub. No.: US 2011/0046957 A1
(43) Pub. Date: Feb. 24, 2011

(54) SYSTEM AND METHOD FOR SPEECH SYNTHESIS USING FREQUENCY SPLICING

(75) Inventors: Susan R. Hertz, Ithaca, NY (US); Harold G. Mills, Ithaca, NY (US)

Correspondence Address: CESARI AND MCKENNA, LLP, 88 BLACK FALCON AVENUE, BOSTON, MA, 02210, US

(73) Assignee: NovaSpeech, LLC, Ithaca, NY (US)

(21) Appl. No.: 12/862,424

(22) Filed: Aug. 24, 2010

Related U.S. Application Data
(60) Provisional application No. 61/236,400, filed on Aug. 24, 2009.

(51) Int. Cl. G10L 13/06; G10L 13/00

(52) U.S. Cl. 704/266; 704/268; 704/E13.001

(57) ABSTRACT

Techniques are disclosed for frequency splicing in which speech segments used in the creation of a final speech waveform are constructed, at least in part, by combining (e.g., summing) a small number (e.g., two) of component speech segments that overlap substantially, or entirely, in time but have spectral energy that occupies disjoint, or substantially disjoint, frequency ranges. The component speech segments may be derived from speech segments produced by different speakers or from different speech segments produced by the same speaker. Depending on the embodiment, frequency splicing may supplement rule-based, concatenative, hybrid, or limited-vocabulary speech synthesis systems to provide various advantages.

### RELATED APPLICATIONS

The present patent application claims priority to U.S. Provisional Patent No. 61/236,400, filed by Susan R. Hertz and Harold G. Mills on Aug. 24, 2009, entitled “SYSTEM AND METHOD FOR SPEECH SYNTHESIS USING FREQUENCY SPLICING”, the contents of which are incorporate by reference herein in their entirety.

### GOVERNMENT LICENSE RIGHTS

The present invention was made with government support under grant number R44 DC006761-02 awarded by the National Institutes of Health. The government has certain rights in the invention.

### BACKGROUND

1. Technical Field

The disclosure below relates generally to speech synthesis and more specifically to splicing together along the frequency dimension speech segments of differing frequency ranges derived from speech segments produced by different speakers and/or from different speech segments produced by the same speaker, to produce complete speech segments.

2. Background

In the past, a variety of systems have been developed to synthesize speech. Such systems can be broadly classified into unlimited-vocabulary systems and limited-vocabulary systems. An unlimited-vocabulary system typically can produce an arbitrary utterance in a particular supported language, or supported languages, based upon a symbolic representation of the utterance such as ordinary text, phonetic transcription, or another type of symbolic representation. Those systems that are capable of synthesizing from ordinary text are commonly referred to as text-to-speech systems. In contrast, a limited-vocabulary system, as we use the term, can only produce a finite number of utterances that are known in advance. Limited-vocabulary systems are sometimes combined with unlimited-vocabulary systems. For example, a limited-vocabulary system might produce a frame utterance such as Turn right on ______ Street, while an unlimited-vocabulary system might generate the appropriate street name.

### Unlimited-Vocabulary Speech Synthesis Systems

Unlimited-vocabulary speech synthesis systems typically include a linguistic analysis (or front end) component and a speech generation (or back end) component. The linguistic analysis component converts the symbolic representation of the utterance to be synthesized (the target utterance) into an abstract linguistic representation (ALR), which depicts the linguistic structure of the target utterance, such as its phrases, words, syllables, syllable nuclei, phonemes, phones, and other linguistic units. On the basis of the ALR, the speech generation component typically generates a speech waveform for the target utterance, which may be played as audible sound or be stored, as desired.

Speech generation components can be divided into a number of basic types including rule-based, concatenative, and hybrid.

Rule-Based Speech Synthesis

In a rule-based speech generation component, a set of context-sensitive rules is applied to an ALR to yield perceptually appropriate synthesizer parameter values. These parameter values are then fed to a speech synthesizer, which produces a speech waveform from them. Note that as used here and elsewhere in this document, the term speech synthesizer refers only to the specific portion of the speech generation component that produces a waveform from a set of parameter values, and does not encompass other portions of the speech generation component such as the rules. While a variety of parameter types may be employed, most commonly the parameters include formant (i.e., vocal tract resonance) frequencies, formant bandwidths, and other acoustic properties of speech. We will call systems that employ a rule-based speech generation component rule-based speech synthesis (RBSS) systems, and RBSS systems that use formant and related parameters rule-based formant synthesis (RBFS) systems.

RBSS systems have a number of advantages, not the least of which is their small memory footprint and the ease with which they can be made to generate different voices, voice characteristics (e.g., different degrees of breathiness), fundamental frequency patterns, and other properties of speech output “on the fly.” Unfortunately, offsetting these positive aspects are certain shortcomings, most notably that speech generated by RBSS generally sounds non-human, having a machine-like timbre or voice quality. Consequently, RBSS systems are generally poorly suited to the production of voices that mimic particular human speakers.

Concatenative Speech Synthesis

In a concatenative speech generation component, speech segments (sometimes called speech units) derived from recorded human speech are taken from a speech database and concatenated to produce a desired utterance. The number, size, and type of speech segments may vary depending on the specific implementation. In some systems, the speech segments are stored directly as digitized waveforms (hereinafter “waveforms”), while in others they are stored in a more compact parametric form obtained through signal processing—for example as linear predictive coding (LPC) coefficients, hidden Markov models (HMMs), or as formant values. We will call all systems that employ a concatenative speech generation component, whether or not their speech segments are waveforms or parametric representations from which waveforms can be derived, concatenative speech synthesis (CSS) systems.

When a parametric representation is used, a speech synthesizer is required to produce the final speech waveform from the parameter values, as in RBSS. In comparison to systems that store speech segments as waveforms, systems using parametric representations generally offer decreased storage requirements and allow for easier manipulation of speech prosody. Offsetting these advantages, however, are certain limitations, the most notable of which is degraded voice quality.

Unlike early parametric CSS systems, which stored a very limited number of specific, predefined speech segments for specific contexts, modern CSS systems often store whole sentences or phrases that are divided via associated labeling into smaller speech segments such as diphones, so that there are generally many speech units available in the database, or corpus, for any given context. Systems offering large databases with many possible speech segments for a given context are often called unit selection systems. A unit selection system uses a variety of acoustic and/or linguistic metrics at synthesis time (i.e., at the time a speech synthesis system is executed) to attempt to select the most appropriate sequence of speech segments for each given context, such that the entire sequence of speech segments will best render the target utterance.

In an effort to produce more natural-sounding voice quality, many modern-day unit selection systems store the speech segments in their speech database as waveforms, rather than in parametric form. Such unit selection systems will be referred to as corpus-based waveform concatenation (CBWC) systems. While CBWC systems may lack the flexibility of RBSS systems, they have the potential to produce speech with a reasonably natural-sounding voice quality that resembles the speaker from whom the speech segments in the database were recorded. Results are especially good in situations where longer segments of contextually appropriate speech from stored utterances can be utilized—for example, whole words. The potential for natural and mimetic CBWC speech, however, may be offset by a variety of shortcomings. For example, natural-sounding CBWC systems generally introduce extensive memory and/or processing requirements that render them suitable only for implementation on high-powered computer systems with a large amount of storage. When the systems are implemented on platforms with storage limitations, some of the speech segments may need to be removed from the speech database, and/or the stored waveforms may need to be downsampled and stored at a lower sampling rate than would otherwise be desirable. For example, the waveforms might be stored at 8,000 samples per second rather than, say, 16,000 samples per second. (Downsampling of speech waveforms is also commonly used in communication systems, including telephony systems, in which speech must be transmitted over channels with limited bandwidth. In such applications, a sampling rate of 8,000 samples per second is often used.)

Both downsampling and a reduction in the number of stored speech segments may lead to a degradation of speech quality. Using a smaller set of speech segments may cause perceptually less appropriate speech segments to be used in the construction of a given utterance. Downsampling of waveforms may cause the loss of perceptually-relevant higher-frequency components. Certain speech segments, like alveolar fricatives (e.g., [s] and [z]) and alveolar stop bursts (e.g., [t] and [d] bursts), which have strong, perceptually-important high-frequency components, are especially prone to degradation through downsampling. In general, speech tends to sound more muffled and less natural at 8,000 samples per second than at higher sampling rates.

Another disadvantage of high-quality CBWC systems is that only a limited number of voices may be provided, since providing additional voices may be prohibitively expensive. This expense results not only from the increased storage requirements of the speech synthesis system itself, but also from increased development requirements—for example, a need for more labor-intensive database preparation and management by the developer of the speech synthesis system.

Hybrid Speech Synthesis

In a hybrid speech generation component, as we use the term, RBSS and CSS approaches are combined. More specifically, RBSS may be used to produce those types of speech segments that can be made to sound reasonably natural when synthesized by rule, such as consonants, while speech segments derived from recorded human speech may be used for those segments that are primarily responsible for the non-human quality of RBSS, such as stressed syllable nuclei. Speech segments produced by RBSS are concatenated with the speech segments derived from the speech database to produce the final speech waveform. Further details regarding hybrid speech synthesis may be found in “System and Method for Hybrid Speech Synthesis” (henceforth the hybrid patent application), by Susan R. Hertz and Harold G. Mills, filed on Apr. 24, 2007, and accorded patent application Ser. No. 11/739,452, which is incorporated in its entirety herein by reference. Systems that employ a hybrid speech generation component will be referred to as hybrid speech synthesis (HSS) systems. HSS systems typically have lower storage requirements than CSS systems, and especially CBWC systems. However, they still share with CSS systems the shortcoming that new speech segments are required for each voice or major variation in voice characteristics. Accurately labeling speech segments with information needed to produce high-quality speech, such as formant frequencies, is time-consuming, even when the number of segments is relatively small. Further, depending on the number of speech segments that are stored, as opposed to synthesized by rule, storage requirements may still be too great for certain applications. Thus, further reduction of the amount of speech material that must be labeled or stored would offer additional advantages.

### Limited-Vocabulary Systems

While the discussion thus far has focused largely on unlimited-vocabulary speech synthesis systems, limited-vocabulary systems share some of the same challenges. Certain of such systems may be able to store the very utterances to be produced as digitized waveforms at reasonably high sampling rates, the very utterances to be produced. However, for some applications, it may be necessary to downsample or encode the waveforms in parametric form due to storage limitations or transmission constraints, such as the limited bandwidth of telephone channels. In such cases, voice quality may be degraded.

Accordingly, there is a need for new speech synthesis techniques that overcome limitations of existing techniques, including the unnatural voice quality of RBSS and parametrically-based CSS systems, voice quality degradations resulting from downsampling, voice quality degradations resulting from reducing the number of stored speech segments in CSS systems, large storage requirements of certain CSS systems, the time-consuming nature of accurate speech database labeling in CSS and HSS systems, and the inability to create new voice characteristics or speech units in flexible ways in certain systems.

### SUMMARY

The shortcomings of the prior art are addressed in part by techniques employing frequency splicing. Broadly speaking, frequency splicing, as used herein, is a technique for speech synthesis in which one or more speech segments used in the production of the final speech waveform are constructed by combining a small number (e.g., two) of spectrally incomplete speech segments that overlap substantially or entirely in time but that have spectral energy that occupies disjoint, or substantially disjoint, frequency ranges. Such spectrally incomplete speech segments may be digitized waveforms or parametric representations from which waveforms can be derived. The spectrally incomplete speech segments may be derived from different sources, including speech segments from different speakers and different speech segments from the same speaker, where the term speaker is used in a broad sense to include both human and synthetic speakers. As explained in more detail below, frequency splicing may be used in a speech synthesis system to improve the voice quality of synthesized speech, to produce different voice characteristics, to produce certain required contextual variants of speech units, to lower speech storage requirements, to restore desired frequency components to speech that has been sent over a band-limited communication channel, to reduce speech database labeling and speech database management time, and/or to provide other benefits.

In a first embodiment, a speech generation component employs RBSS to create a sequence of one or more base speech segments. Some of these base speech segments may be missing certain frequency components, either because they were generated without these frequencies or because they were filtered after being generated. The sequence of base speech segments is sent to a frequency splicing engine which completes any incomplete base speech segments by combining them with augmentative speech segments derived from a speech database, resulting in a sequence of complete speech segments. An augmentative speech segment may undergo certain modifications to make it compatible with the incomplete base speech segment with which it will be combined, as discussed below. After all speech segments are complete, they are concatenated to produce a final speech waveform.

In a second embodiment, a speech generation component employs CSS or HSS to construct a base speech waveform that is labeled to identify those speech segments of the base speech waveform that need completion, either because they were generated without these frequencies or because they were filtered after being generated. The base speech waveform is sent to a frequency splicing engine, which combines any incomplete speech segments in the base speech waveform with compatible augmentative speech segments created by an augmentative synthesis module, resulting in a final speech waveform.

In a third embodiment, a limited-vocabulary speech synthesis system produces a base speech waveform containing one or more speech segments in need of completion. A frequency splicing engine combines the incomplete speech segments in the base speech waveform with compatible augmentative speech segments, in a manner similar to that described for the second embodiment above.

Frequency splicing may also be used to advantage to overcome limitations of existing synthesis systems. In an RBSS system, for example, frequency splicing may be used to improve the naturalness or mimetic accuracy of the system by constructing certain base speech segments (e.g., those corresponding to syllable nuclei) to contain lower frequencies up to a certain cutoff frequency (e.g., between the third and fourth formant frequencies), and then adding compatible augmentative speech segments taken from a speech database of natural speech that contain the higher frequencies. As but another example, in a client-server speech application that involves transmitting RBSS-synthesized speech over a limited bandwidth communication channel (e.g., a telephony system), the client may augment a received limited bandwidth base speech waveform with higher-frequency augmentative speech segments that are generated by RBSS or taken from a speech database.

Frequency splicing may also be used to advantage in HSS- and CSS-based systems. As but one example, speech database storage requirements may be reduced with little if any degradation in voice quality by storing only lower-frequency speech components (e.g., in downsampled speech waveforms) and augmenting these at synthesis time with higher-frequency components either produced by an augmentative synthesis module or taken from a smaller speech database. A single augmentative speech segment containing higher-frequency [s] noise, for example, may be used to augment many different incomplete base speech segments for the phone [s] in many different phonetic contexts, since [s] noise has similar characteristics across many contexts, and small variations are often not perceptually important. Storage requirements may also be reduced by producing contextual variants of speech segments through frequency splicing, rather than by storing all of the different variants. For example, a nasal variant of a vowel (for use, e.g., before a nasal consonant) may be produced from a non-nasal variant by replacing lower-frequency components of the non-nasal variant with lower-frequency components from an appropriate nasalized vowel. As but another example advantage, speech database labeling time can be reduced by supplementing speech segments containing only lower-frequency components (e.g., syllable nuclei containing only the first three formants) with RBSS-generated augmentative speech segments containing the less variable higher formants (e.g., the fourth formant and above). In such a system, the higher-frequency formants do not need to be labeled with their frequency values since these values are not used by the system. (Formant frequencies and other speech metadata may be stored in the speech database of a unit selection system for the purpose of selecting speech database units that will fit together without producing audible artifacts.) As still another example, different voice characteristics can be created by combining incomplete base speech segments with augmentative speech segments from different speakers or of different phonation types (e.g., non-breathy and breathy).

Frequency splicing can also provide benefits in a limited-vocabulary system. For example, storage and/or transmission requirements can be reduced as described above for HSS- and CSS-based systems.

### BRIEF DESCRIPTION OF THE DRAWINGS

The description below refers to the accompanying drawings, of which:

FIG. 1 is a block diagram of an example computing device that may execute a speech synthesis system employing frequency splicing;

FIG. 2 is a block diagram of a linguistic analysis component that may be used in a speech synthesis system employing frequency splicing;

FIG. 3 is a set of example spectrograms that illustrates frequency splicing of frequency splicing components (FSCs) to produce a complete speech segment used in a final speech waveform;

FIG. 4 is a diagram that illustrates the application of compatibility adaptations to an augmentative FSC that is combined with a base FSC to produce a complete speech segment.

FIG. 5 is a flow diagram of an example sequence of steps for modifying a best available augmentative FSC so that it is compatible for combination with a base FSC.

FIG. 6A is a block diagram of an example speech generation component that utilizes RBSS in conjunction with frequency splicing;

FIG. 6B is a flow diagram of an example sequence of steps for supplementing RBSS with frequency splicing;

FIG. 7A is a block diagram of an example speech generation component that utilizes CSS or HSS in conjunction with frequency splicing;

FIG. 7B is a flow diagram of an example sequence of steps for supplementing CSS or HSS with frequency splicing;

FIG. 8 is a set of example spectrograms that illustrates frequency splicing in a synthesis system in which the boundaries of speech segments concatenated to form a base speech waveform do not align with frequency splicing boundaries;

FIG. 9 is a block diagram of an example limited-vocabulary speech generation component that employs frequency splicing;

FIG. 10 is a set of example spectrograms that illustrates the combination of a base FSC produced by an RBSS synthesis system with an augmentative FSC derived from a speech database to produce a complete syllable nucleus speech segment;

FIG. 11 is a set of example spectrograms that illustrates the combination of a base FSC containing lower-frequency components of a consonant with an augmentative FSC containing higher-frequency components to produce a complete consonant speech segment;

FIG. 12 is a set of example spectrograms that illustrates the combination of a base FSC containing lower-frequency components of a non-breathy vowel speech segment with an augmentative FSC containing higher-frequency components of a breathy vowel to produce a breathy-sounding vowel;

FIG. 13 is a set of example spectrograms that illustrates the combination of a base FSC containing higher-frequency components of a non-nasalized vowel with an augmentative FSC containing lower-frequency components of a nasalized vowel to produce a nasal-sounding vowel.

### DETAILED DESCRIPTION

### Overview of Frequency Splicing Concepts

Frequency splicing, as used herein, is a technique for speech synthesis in which one or more speech segments used in the production of the final speech waveform are constructed by combining a small number (e.g., two) of spectrally incomplete speech segments that overlap substantially or entirely in time but that have spectral energy that occupies disjoint, or substantially disjoint, frequency ranges. As used herein, the term speech segment refers to an interval of speech (possibly spectrally incomplete) consisting of a sequence of waveform samples (or parameters from which such samples can be derived) and associated metadata describing properties of the speech, such as duration, glottal pulse times, and/or others. A spectrally incomplete speech segment is one that is missing frequency components in one or more frequency ranges desired in the final speech output. Spectrally incomplete speech segments that are combined by frequency splicing are referred to as frequency splicing components (FSCs). A complete speech segment is any speech segment containing all desired frequency components, whether produced through frequency splicing or not. The term frequency spliced segment (FSS) refers to a complete speech segment that is produced through frequency splicing.

Frequency splicing may be used to supplement any kind of speech synthesis system, including RBSS, HSS, CSS, and limited-vocabulary systems. The speech generation component of a frequency splicing synthesis system typically contains a base synthesis module, which may be an enhanced version of the speech generation component of a conventional synthesis system, as well as additional components that perform frequency splicing and other functions. As used herein, base speech segments are speech segments produced by a base synthesis module. These base speech segments may be produced separately by the base synthesis module for later concatenation, or they may be delimited portions of a longer stretch of speech produced by the base synthesis module. A longer stretch of speech in waveform (i.e., not parametric) form that contains base speech segments is referred to as a base speech waveform.

An FSS may be formed by combining a base FSC and one or more augmentative FSCs. A base FSC is an FSC that is derived from a base speech segment. A base FSC may be derived from a spectrally complete base speech segment via frequency selective filtering, as may be the case, for example, if the base synthesis system produces full-bandwidth speech output. Alternatively, a base FSC may be produced directly by an RBSS, HSS, CSS, or limited-vocabulary base synthesis system that has been enhanced to be able to produce spectrally incomplete FSCs. For example, an HSS or CSS system may be enhanced so that appropriately filtered units (i.e., base FSCs) are stored in a speech database (where the term speech database as used herein to refers to any repository of stored speech segments and any associated metadata), so that they do not need to be filtered at synthesis time. An RBFS system may be enhanced so that it can synthesize any specified subset of the usual formants, omitting the others.

An augmentative FSC is a spectrally incomplete speech segment having frequency components in the one or more desired frequency ranges that are missing from a base FSC with which it will be combined. An augmentative FSC may be thought of as a “patch” that fills one or more of the “holes” of a base FSC.

An augmentative FSC may be derived either from an augmentative speech database, or it may be produced by an augmentative synthesis module. The term augmentative speech database as used herein refers to any speech database from which augmentative speech segments are derived. Such a database may store individual predetermined augmentative FSCs derived from any type of speaker (e.g., the higher-frequency components of an [s] speech segment produced either by a human speaker or an RBSS system), and/or a corpus of whole sentences, phrases, and/or other units from which augmentative FSCs may be extracted. (Alternatively, the database may store complete speech segments that are later filtered to produce the appropriate augmentative FSCs.) An augmentative speech database may be a separate speech database that only contains speech from which augmentative FSCs are derived, or it may be one from which base FSCs are also so derived.

An augmentative synthesis module is a component of a frequency splicing synthesis system that may be used to produce augmentative FSCs (or complete speech segments that are later filtered to become augmentative FSCs) at synthesis time. Such a module, for example, may be an RBFS synthesis module that has been adapted to produce augmentative FSCs based on a specification of their desired properties.

A base FSC and any of the augmentative FSCs with which it is combined may be derived from speech segments produced by different speakers, or they may be derived from different speech segments produced by the same speaker, where the term speaker is used in a broad sense to include both human and synthetic speakers (for example, a synthetic speaker may be an RBSS system). Depending on the particular synthesis system, an FSC may correspond to any kind of linguistic unit or portion thereof—e.g., a phone (either in the sense used in the hybrid patent application or in the more conventional sense), a transition (in the sense used in the hybrid patent application), a diphone, a stop burst, a phoneme-sized unit, and/or smaller pieces or larger sequences of the foregoing.

As discussed further below, the linguistic and/or acoustic properties of an augmentative FSC and a base FSC with which it will be combined do not need to match. For example, a higher-frequency augmentative FSC derived from the mid front vowel [ey] (e.g., the vowel of say) may be combined with a lower-frequency base FSC for the low central vowel [a] (e.g., the first vowel of father) or with a different vowel or even with a non-vowel speech segment. Further, an FSC extracted from one type of unit (e.g., a phone) may be combined with another type of unit, (e.g., a syllable). In addition, the linguistic and/or acoustic context (e.g., the linguistic and/or acoustic properties of neighboring segments) from which an augmentative FSC is taken may be different than that of a base FSC with which it is combined.

The FSCs combined to produce a complete speech segment may be waveforms or parametric representations from which waveforms can be derived (and any associated metadata). The technique used to create a complete speech segment from the base and augmentative FSCs will vary in accordance with the details of the representations. As but one example, when the FSCs are waveforms, they may be combined by standard waveform combination techniques such as sample by sample summation. As but another example, when the FSCs are represented in terms of parameters that include line spectral pairs (LSPs), the full set of LSPs for the complete speech segment may be produced by taking the LSPs for different frequency ranges from different FSCs.

Depending on the origin of an augmentative FSC, the augmentative FSC may be incompatible in various ways with a base FSC with which it is to be combined. For example, when an augmentative FSC is derived (e.g., by frequency-selective filtering) from stored human speech, its duration, amplitude, and fundamental frequency contour may differ in undesirable ways from those of the base FSC. It is typically desirable to modify an augmentative FSC in ways that make it more compatible with the base FSC with which it will be combined in order to create a complete speech segment that is perceptually appropriate for its context in the final synthesized utterance. We will refer to such modifications as compatibility adaptations. Operations performed by compatibility adaptations may include amplitude modification, fundamental frequency modification, removal of an initial and/or final portion of a speech segment, time scale modification, and other modifications.

In some implementations, it may be advantageous to apply compatibility adaptations to complete speech segments that are subsequently filtered to produce augmentative FSCs, rather than directly to the augmentative FSCs themselves. In any subsequent examples in which compatibility adaptations are applied to augmentative FSCs, it should be understood that these might be applied instead to complete speech segments that are subsequently filtered to produce augmentative FSCs.

As explained in more detail below, frequency splicing may be used in a speech synthesis system to improve the voice quality of synthesized speech, to produce different voice characteristics, to produce certain required contextual variants of speech units, to lower speech storage requirements, to restore desired frequency components to speech that has been sent over a band-limited communication channel, to reduce speech database labeling and speech database management time, and/or to provide other benefits.

### Example Embodiments

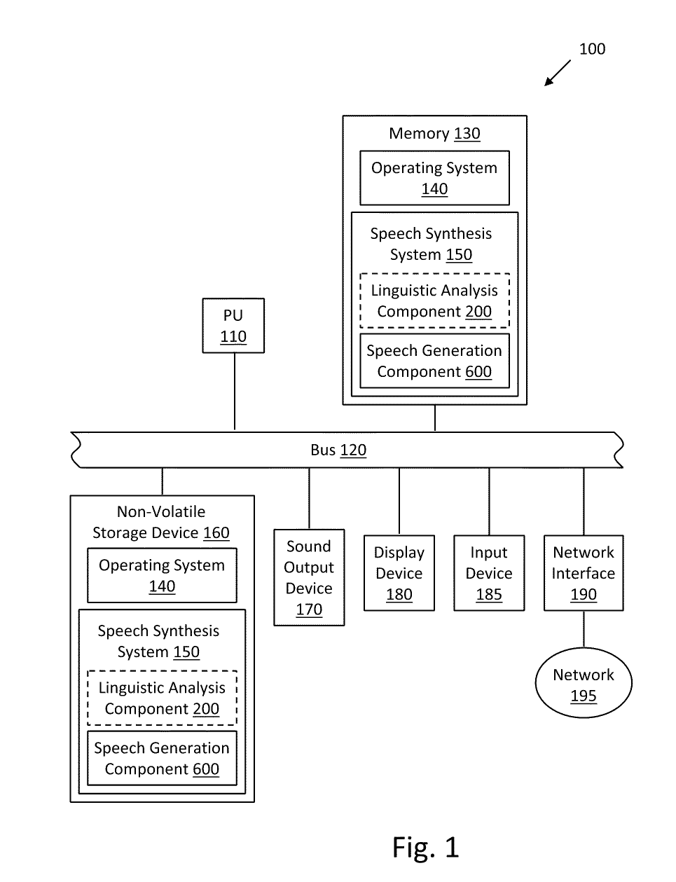

FIG. 1 is a block diagram of an example computing device 100 that may execute a speech synthesis system employing frequency splicing. The computing device 100 may be a personal computer (PC), a portable speech synthesis device (for example, for speech-impaired individuals), a telephone, such as a cellular telephone or Internet Proton col (IP) phone, or another type of device having at least some processing capabilities. The example computing device 100 includes a processing unit (PU) 110 coupled to a bus 120. The PU 110 may be any of a variety of commercially available processors, for example, a Complex Instruction Set Computer (CISC) processor, a Reduced Instruction Set Computer (RISC) processor, or another type of processor. A volatile memory 130, such as a Random Access Memory (RAM), is coupled to the bus 120. The volatile memory 130 may be adapted to store at least a portion of executable instruction code for an operating system 140 while the computing device 100 is operating. The memory 130 may further be adapted to store at least portions of executable instruction code for a speech synthesis system 150, which may take the form of an RBSS, CSS, HSS, or limited-vocabulary speech synthesis system, depending on the particular embodiment. In addition to a speech generation component 600, the speech synthesis system 150 may include a linguistic analysis (or front end) component 200 and/or other structures.

The bus 120 may also be coupled to a variety of other units. Such coupling may be via a direct connection, or alternately via certain intermediary devices and/or buses (not shown). A non-volatile storage device 160, such as a hard disk drive, a solid-state memory, or other type of storage device, may be coupled to the bus 120 and persistently maintain the operating system 140, speech synthesis system 150, and any other software present on the computing device 100. In addition to the non-volatile storage device 160, a sound output device 170, for example an amplified audio speaker, and a display device 180 may be coupled to the bus 120. Similarly, one or more input devices 185, such as a keyboard, a mouse, a trackball, a touch sensor, a microphone, or another type of input device, may be provided for interacting with the speech synthesis system 150. Finally, a network interface 190 may be provided for communication with a network 195—for example the Internet or a public switched telephone network. Such communication may be via a wired or wireless network connection, using any of a number of network protocols. While FIG. 1 shows a speech synthesis system 150 executing in a standalone manner on the computing system 100, it should be remembered that a speech synthesis system 150 alternately may be structured according to a client-server, or other, distributed computing model, and various functionality therefore may be provided by separate computing devices (not shown). Similarly, while FIG. 1 shows the speech synthesis system 150 embodied in executable instruction code, resident, at least in part, in a volatile memory 130 and a non-volatile storage device 160, where the executable instruction code is executed by a PU 110, it should be remembered that the speech synthesis system 150 may alternately be embodied in specially-built and/or specially-configured hardware—for example, in one or more a programmable logic devices (PLD), Application Specific Integrated Circuits (ASICs), or the like, or embodied as a combination of executable instruction code and specially-configured hardware devices.

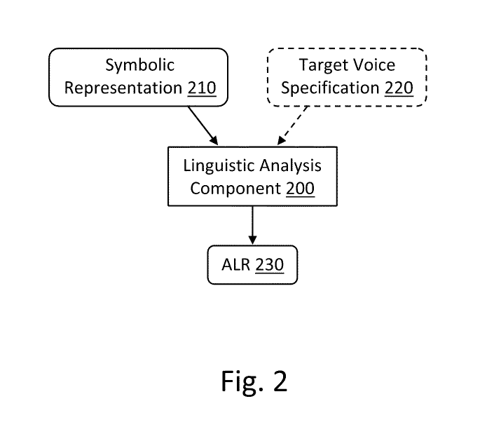

FIG. 2 is a block diagram of a linguistic analysis component 200 that may be used in a speech synthesis system 150 employing frequency splicing. The linguistic analysis component 200 accepts a symbolic representation 210 of an utterance, such as ordinary text, and produces an abstract linguistic representation (ALR) 230. While some characteristics of the target voice may be provided within the symbolic representation 210, they may also be specified independently, in a separate target voice specification 220, which is passed to the linguistic analysis component 200. The target voice specification 220 may include an identifier of a specific target voice, of a number of available target voices in the speech system 150, or alternatively may include a set of desired voice characteristics, such as gender, age, and/or particular voice properties (e.g., breathy, non-breathy, high-pitched, low-pitched, etc.)

The ALR 230 and, in some implementations, the target voice specification 220, are supplied to a speech generation component 600, the configuration of which differs according to the specific embodiment. In each embodiment, however, the speech generation component 600 employs frequency splicing in generation of a final speech waveform.

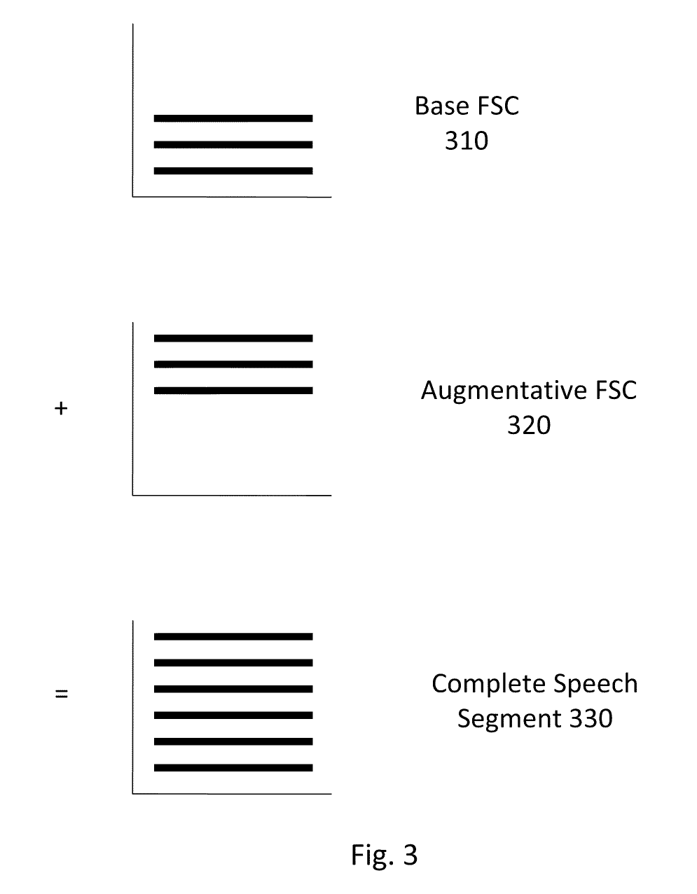

FIG. 3 is a set of schematic spectrograms that illustrates the frequency splicing of FSCs to produce a complete speech segment used in the production of a final speech waveform. As in actual speech spectrograms, the vertical axis represents frequency and the horizontal axis represents time. The horizontal lines within the area bounded by the axes represent formants. In FIG. 3, a base FSC 310 containing the first three formants is combined with an augmentative FSC 320 containing the fourth through sixth formants to produce a complete speech segment 330. It should be noted that while the formants are shown as level bars equally spaced in frequency, real speech segments may have formant frequencies that vary over the course of the speech segment, and that are not equally spaced, and the cutoff frequency for the filtering may therefore depend on the particular formant frequencies of the speech segments in question.

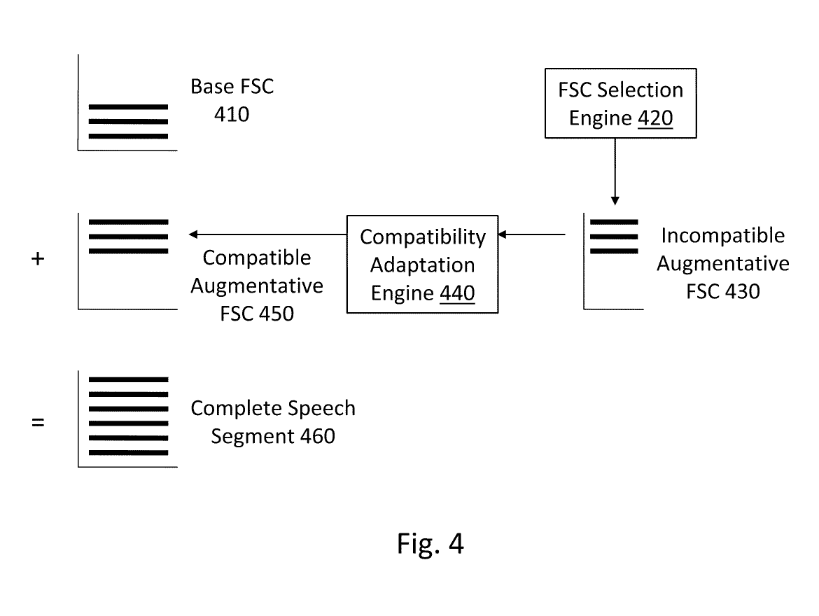

FIG. 4 illustrates the application of compatibility adaptations to an incompatible augmentative FSC that is to be combined with a base FSC to produce a complete speech segment. The base FSC 410 contains three formants and is missing formants four and above. An FSC selection engine 420 determines a best available augmentative FSC 430 containing formants four through six. As can be seen in the figure, the augmentative FSC 430 has a duration that is substantially shorter than that of the base FSC, and it may have other incompatibilities as well. For example, if the augmentative FSC 430 is a waveform, it may have glottal pulse times that are incompatible with those of the base speech segment. The augmentative FSC 430 is sent to a compatibility adaptation engine 440, which modifies its duration to be the same as that of the base FSC 410 and makes any other necessary adjustments.

To determine the necessary adaptations, the compatibility adaptation engine 440 may access the metadata of the base FSC, such as amplitudes, glottal pulse marks, formant frequencies, and other information. After the appropriate adaptations have been made, the base FSC 410 and the compatible augmentative FSC 450 are combined to produce a complete speech segment 460.

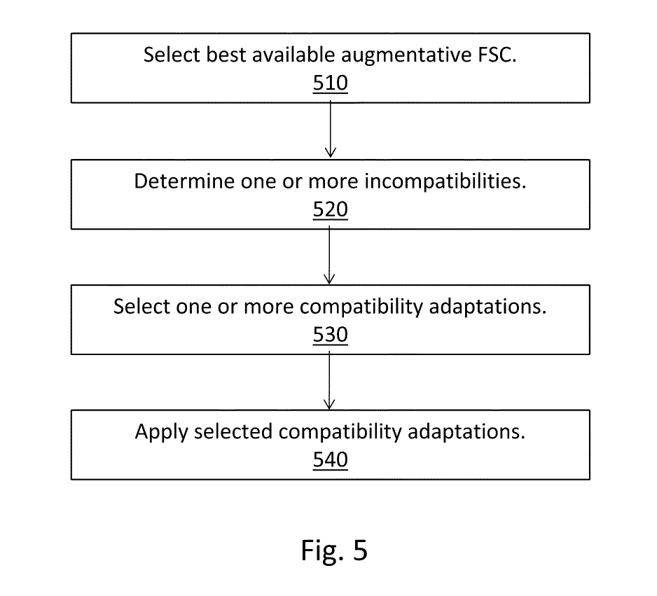

FIG. 5 is a flow diagram of an example sequence of steps for modifying an incompatible augmentative FSC with compatibility adaptations. At step 510, a best available augmentative FSC is selected. At step 520, one or more incompatibilities are determined. At step 530, the necessary compatibility adaptations are selected. At step 540, the selected compatibility adaptations are applied to the incompatible augmentative FSC to generate a compatible FSC.

While the examples shown in FIGS. 4 and 5 only show compatibility adaptations applied to a single best available augmentative FSC, in certain implementations, compatibility adaptations may be applied to multiple augmentative FSCs that are to be combined with a single base FSC, and/or they may be applied to the base FSC itself.

Note that when an augmentative FSC is created by a synthesis module that produces a speech waveform from parameters using a speech synthesizer, no compatibility adaptations may be required if the synthesizer is able to produce FSCs with all desired properties.

Rule-Based Speech Generation Employing Frequency Splicing

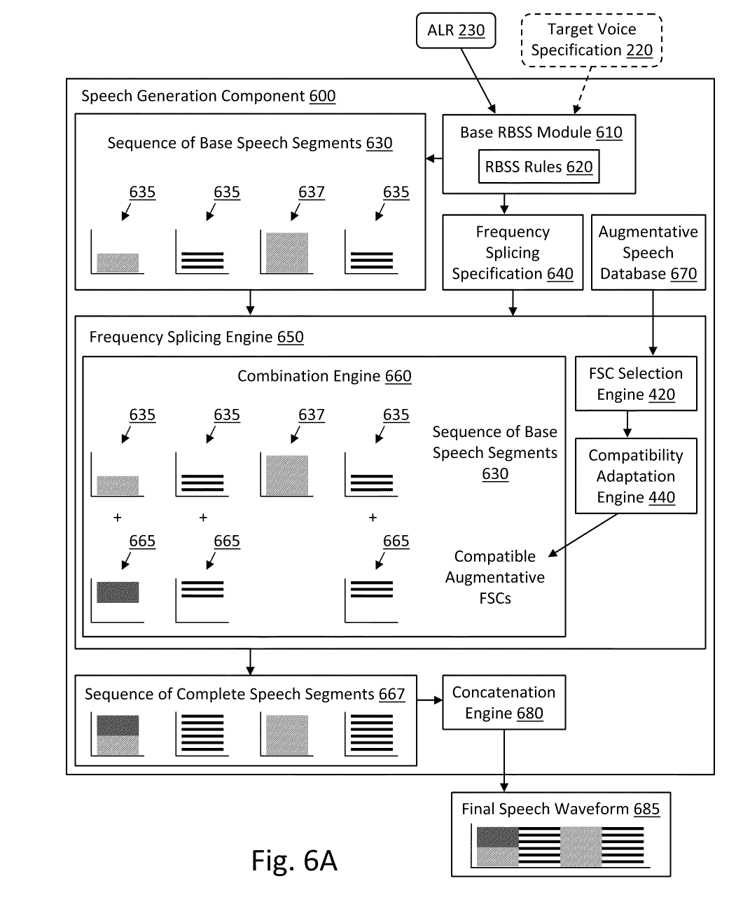

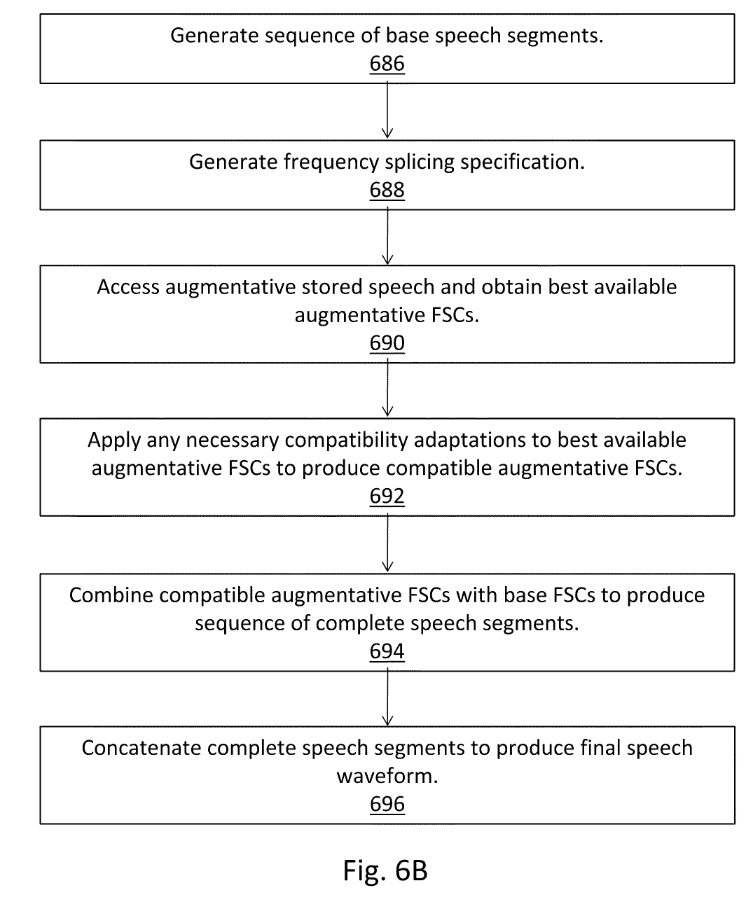

In one embodiment, the speech generation component 600 may utilize RBSS to generate base speech segments, one or more of which will function as base FSCs for frequency splicing. FIG. 6A is a schematic block diagram of an example speech generation component 600 that operates in this fashion. The speech generation component 600 receives an ALR 230 from the linguistic analysis component 200, and, in some cases, a separate target voice specification 220. The ALR 230 and, if present, the target voice specification 220 are passed to a base RBSS module 610 that applies a set of RBSS rules 620 to yield a sequence of base speech segments 630 represented as waveforms. (Note that, as discussed above, the RBSS module 610 would first produce sets of parameter values from which the waveforms are produced using a speech synthesizer.) In the figure, these base speech segments and other speech segments are represented by schematic spectrograms as in FIGS. 3 and 4. In the schematic spectrograms, for purposes of discussion, we will assume that solid dark areas represent portions of speech segments containing relatively high-intensity noise (e.g., the higher frequencies of [s]), hatched areas represent portions of speech segments containing relatively low-intensity noise (e.g., [f]), and areas with horizontal bands represent vowels or longer syllable nuclei.

At least some of the base speech segments 630 are base FSCs 635—that is, the base speech segments lack certain frequency components that will be supplied by one or more augmentative FSCs. The RBSS module 610 may be configured to produce base FSCs only for certain types of speech segments, such as vowels or longer syllable nuclei. These base FSCs may be augmented later, for example with higher formants from another source for syllable nuclei. Note that in the figure, segment 637 is a complete speech segment. The base RBSS module 610 may also generate a frequency splicing specification 640, which may include information such as which base speech segments should be augmented (i.e., considered as base FSCs 635) and what type of augmentation is required.

The sequence of base speech segments 630 and the frequency splicing specification 640 are passed to the frequency splicing engine 650. The frequency splicing engine may include an FSC selection engine 420, a compatibility adaptation engine 440, and a combination engine 660. The FSC selection engine 420, in response to the frequency splicing specification 640, accesses an augmentative speech database 670, and, for each base FSC, extracts from the augmentative speech database one or more best available augmentative FSCs. The best available augmentative FSCs are sent to a compatibility adaptation engine 440, which modifies the augmentative FSCs by application of any required compatibility adaptations. As discussed above, the compatibility adaptations may include amplitude modification, fundamental frequency modification, removal of an initial and/or final portion of a speech unit, time scale modification, and/or other modifications. The now compatible augmentative FSCs 665 are passed to the combination engine 660, which combines them with the appropriate base FSCs 635 of the sequence of base speech segments 630.

Best available augmentative FSCs may be selected on linguistic, acoustic, perceptual and/or other grounds, and the linguistic and/or acoustic properties of augmentative segments and their base FSCs may not be the same. As but one of many possible examples, [h] noise may be added to a vowel to create a breathy percept, or the higher-frequency components of one vowel may be added to the lower-frequency components of another, as discussed below.

It should be remembered that while FIG. 6A depicts one compatible augmentative FSC 665 being added to each base FSC 635, in other implementations, some, or all, of the base FSCs 635 may be combined with multiple compatible augmentative FSCs 665, in order to complete the base FSCs 635. In addition, a single augmentative FSC may be added to multiple base FSCs, with either the same or different compatibility adaptations.

Depending on the particular implementation, the FSC selection engine 420, the compatibility adaptation engine 440, and the combination engine 660 may operate in series, in parallel, or in a combination thereof. In a parallel processing implementation, for example, the compatibility adaptation engine 440 and/or the combination engine 660 need not wait for the FSC selection engine 420 to select all augmentative FSCs. Rather, as sufficient information becomes available regarding any one particular augmentative FSC, these engines may begin their processing. Operation in this fashion may reduce system latency—that is, the time between when the first part of the input becomes available and the first part of the output is produced.

The combination engine 660 combines base FSCs 635 with the appropriate augmentative FSCs 665 to produce complete speech segments. The sequence of complete speech segments 667 for the utterance (consisting of those that were produced through frequency splicing as well as those that did not require frequency splicing) is then supplied to a concatenation engine 680, which joins them to produce a final speech waveform 685, which may be played audibly or stored, as desired.

FIG. 6B is a flow diagram of an example sequence of steps for supplementing RBSS with frequency splicing. At step 686, a sequence of base speech segments 630, including one or more base FSCs 635, is generated. At step 688, a frequency splicing specification 640 is generated. At step 690, in response to the frequency splicing specification 640, augmentative stored speech 670 is accessed and a set of best available augmentative FSCs is obtained. At step 692, the best available augmentative FSCs may undergo compatibility adaptations to produce compatible augmentative FSCs 665 or may be passed on as compatible augmentative FSCs 665 if no compatibility adaptations are required. At step 694, compatible augmentative FSCs 665 are combined with the base FSCs 635 to produce complete speech segments 667. Finally, at step 696, the complete speech segments 667 are concatenated to produce a final speech waveform 685.

By utilizing frequency splicing, the final speech waveform 685 may have a more natural-sounding voice quality, may better mimic a particular human speaker, or may have specific voice characteristics that cannot be produced using RBSS techniques alone.

It should be remembered that while the above embodiment operates in terms of speech waveform segments, the FSCs can also be represented parametrically. In this case, a base FSC and one or more augmentative FSCs would be combined in their parametric form and sent to a speech synthesizer, which would produce a speech waveform segment from them, either before or after concatenation with neighboring speech segments.

Further, it should be understood that while the above embodiment produces base speech segments using RBSS, the base speech segments may instead be produced by HSS or CSS.

Concatenative or Hybrid Speech Generation Employing Frequency Splicing

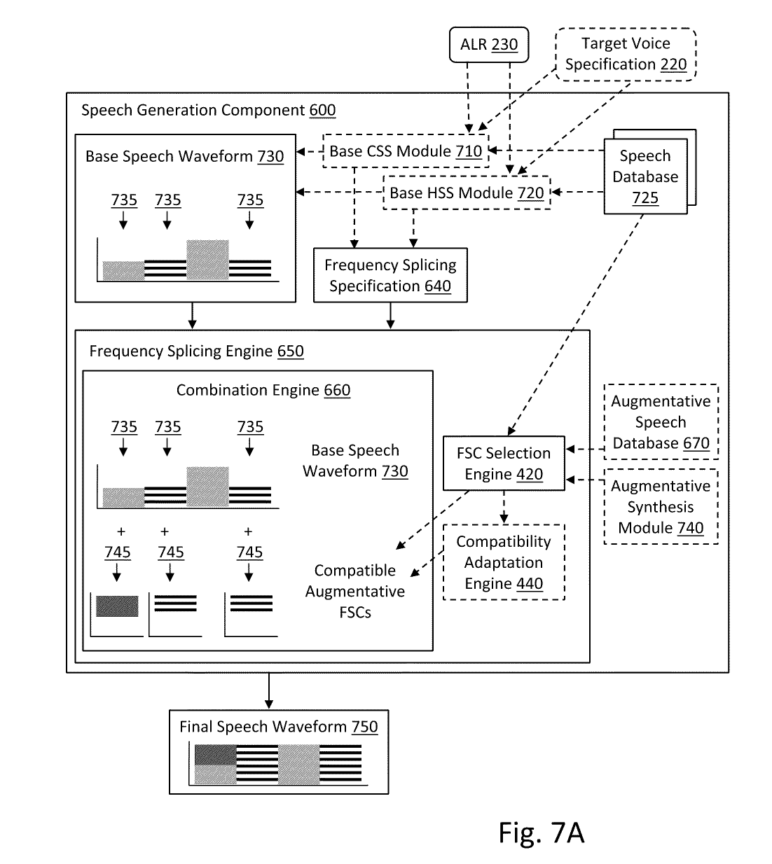

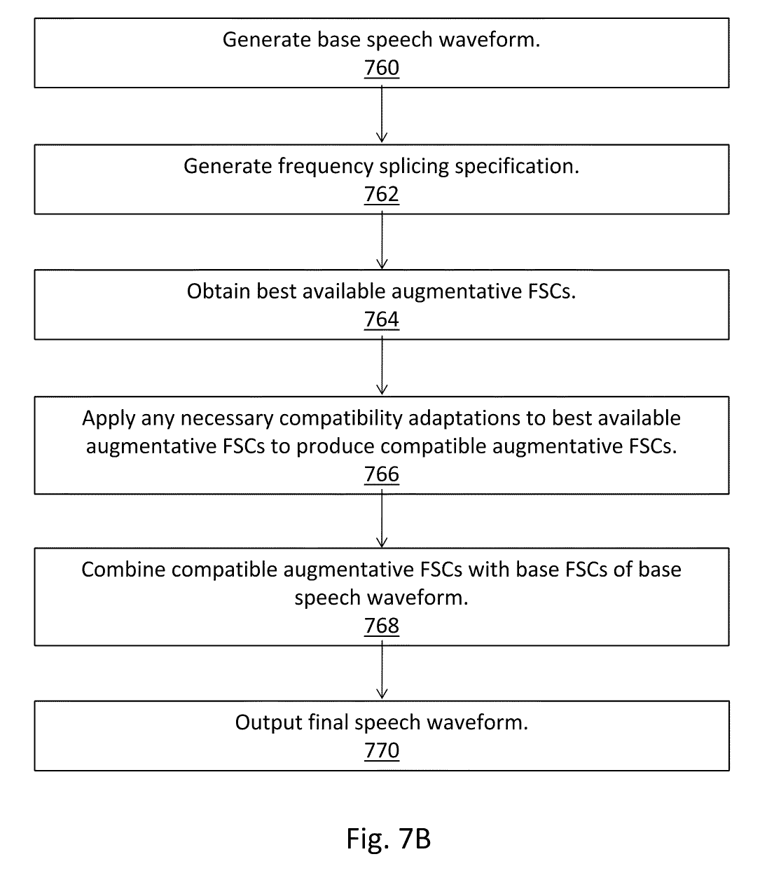

In another embodiment, the speech generation component 600 may utilize CSS or HSS to construct a base speech waveform including one or more base speech segments that are intended to serve as base FSCs. FIG. 7A is a schematic block diagram of an example speech generation component 600 that utilizes CSS or HSS in conjunction with frequency splicing. The speech generation component 600 receives an ALR 230 from the linguistic analysis component 200, and, in some cases, a target voice specification 220. The ALR 230 and, if present, the target voice specification 220, are passed to either a base CSS module 710 or a base HSS module 720, depending on the particular implementation. Typically, only one such module 710, 720 is present.

The base CSS module 710 or HSS module 720 constructs a speech waveform 730 that represents the target utterance, utilizing one or more speech databases 725 that typically store speech units recorded from a human speaker—for example as digitized waveforms, in a parametric form, or as a combination thereof. At least portions of the base speech waveform 730 may have been appropriately filtered so that they may serve as base FSCs 735. In addition, the module 710, 720 may generate a frequency splicing specification 640, which may include information descriptive of any absent frequency components in the base FSCs 735. The information may include, for example, indications of speech segments that should be augmented (i.e., used as base FSCs 735), as well as indications of the type of augmentation required.

The base speech waveform 730 and the frequency splicing specification 640 are passed to a frequency splicing engine 650. The frequency splicing engine 650 may include an FSC selection engine 420, a compatibility adaptation engine 440, and a combination engine 660. The FSC selection engine 420, in response to the frequency splicing specification 640, may access an augmentative speech database 670 and extract therefrom a set of best available augmentative FSCs. Such a speech database may store individual predefined augmentative FSCs recorded from a human speaker and/or a speech database of whole sentences or phrases derived from a human speaker from which augmentative FSCs may be extracted. Alternately, the FSC selection engine 420 may access one or more of the speech databases 725 used by the base CSS module 710 or the base HSS module 720 to obtain the best available augmentative FSCs. In yet another alternative, the FSC selection engine 420 may communicate with an augmentative synthesis module 740 that generates augmentative FSCs 745. In still another alternative, some combination of the above described sources of augmentative FSCs may be employed with differing augmentative FSCs originating from differing sources and/or differing speakers.

The best available augmentative FSCs are sent to a compatibility adaptation engine 440, which modifies these FSCs if necessary by application of compatibility adaptations. As discussed above, the compatibility adaptations may include amplitude modification, fundamental frequency modification, removal of an initial and/or final portion a speech unit, time scale modification, and/or other modifications. The now compatible augmentative FSCs 745 are passed to the combination engine 660. Note that, especially in an implementation where augmentative FSCs 745 are obtained exclusively from an augmentative synthesis module 740, there may be no compatibility engine in the system, since the augmentative FSCs 745 may require no further adaptation. Thus, in such cases, the augmentative FSCs 745 may pass directly to the combination engine 660. The combination engine 660 adds compatible augmentative FSCs 745 to base FSCs 735 of the base speech waveform 730 to produce a final speech waveform 750, which may be played audibly or stored, as desired.

It should be understood that not every portion of the base speech waveform 730 need be combined with augmentative FSCs 745. Further, while FIG. 7A depicts only one compatible augmentative FSC 745 being added to each base FSC 735, in other implementations, some or all of the base FSCs 735 may be combined with multiple compatible augmentative FSCs 745. In addition, depending on the particular implementation, the FSC selection engine 420, compatibility adaptation engine 440, and combination engine 660 may operate in series, in parallel, or in another manner.

FIG. 7B is a flow diagram of an example sequence of steps for supplementing a CSS-based or HSS-based speech synthesis system with frequency splicing. At step 760, a base speech waveform 730, including one or more base FSCs 735, is constructed. At step 762, a frequency splicing specification 640 is generated. At step 764, in response to the frequency splicing specification 640, a set of one or more best available augmentative FSCs 745 is obtained for each base FSC 735, for example by accessing augmentative stored speech, by RBSS, or by a combination of techniques. At step 766, the best available augmentative FSCs are subject to one or more compatibility adaptations, if required, to produce compatible augmentative FSCs 745. As discussed above, especially if the best available augmentative FSCs are produced by RBSS they may already be compatible augmentative FSCs, and thus separate application of compatibility adaptations may not be needed. At step 768, compatible augmentative FSCs 745 are combined with the base FSCs 735 of the base speech waveform 730. Finally, at step 770, a final speech waveform 750 is produced. By utilizing frequency splicing, the final speech waveform 750 may be produced by a system having lower storage or transmission requirements than would otherwise be necessary. Similarly, the final speech waveform may be made to better mimic a particular human speaker, to be more natural-sounding, to have fewer audible artifacts, or to have specific voice characteristics.

While the above embodiment produces a base speech waveform using HSS or CSS, it should be understood that the base speech waveform may instead be produced by RBSS.

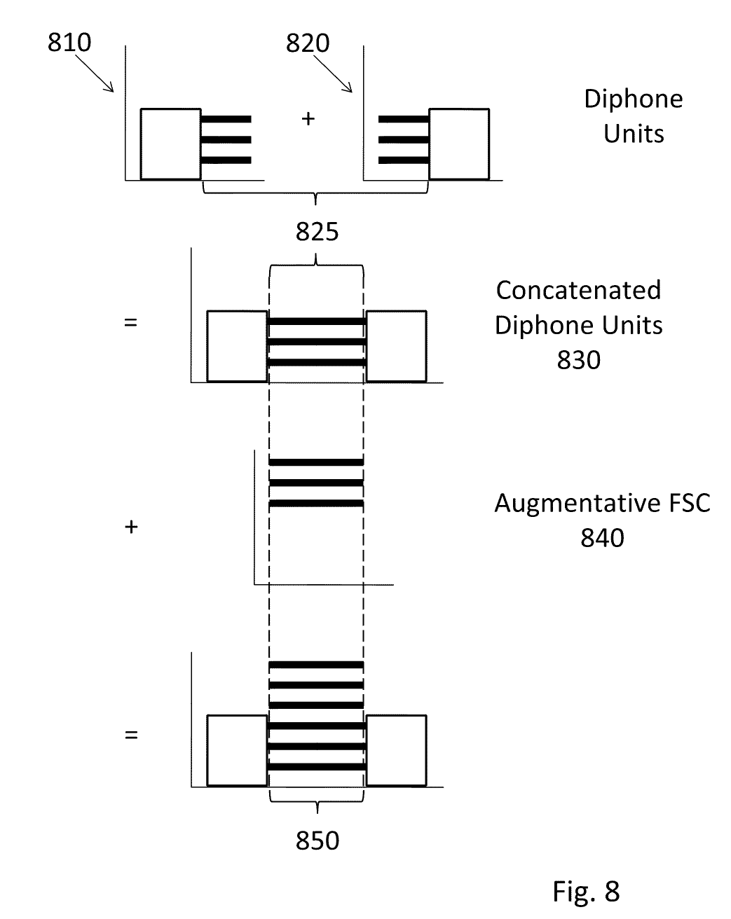

It should be understood that concatenation boundaries that occur in the base speech waveform 730 may, or may not, align with the boundaries of augmentative FSCs. For example, FIG. 8 shows a set of example spectrograms that illustrates frequency splicing involving concatenated diphones, where we assume for purposes of discussion that the diphone unit 810 contains the second half of a consonant (depicted in the figure as a non-filled rectangular box) followed by the first half of a vowel (depicted as horizontal lines), and that the diphone unit 820 contains the second half of a vowel followed by the first half of a consonant, and that the diphone units 810, 820 have been low-pass filtered just above the frequency of the third formant of the vowel. Assume, for example, that the diphone units 810, 820 are [sly] and [iyd] respectively, which may be combined in the production of the syllable seed. The diphone units 810, 820 may be obtained from the one or more speech databases 725 and concatenated 825 to produce a base waveform of concatenated diphones 830. A single augmentative FSC 840 may then be combined with the vowel portion of the concatenated diphone units 830 to produce a complete vowel segment 850 for use in the final speech waveform.

Limited-Vocabulary Speech Generation Employing Frequency Splicing

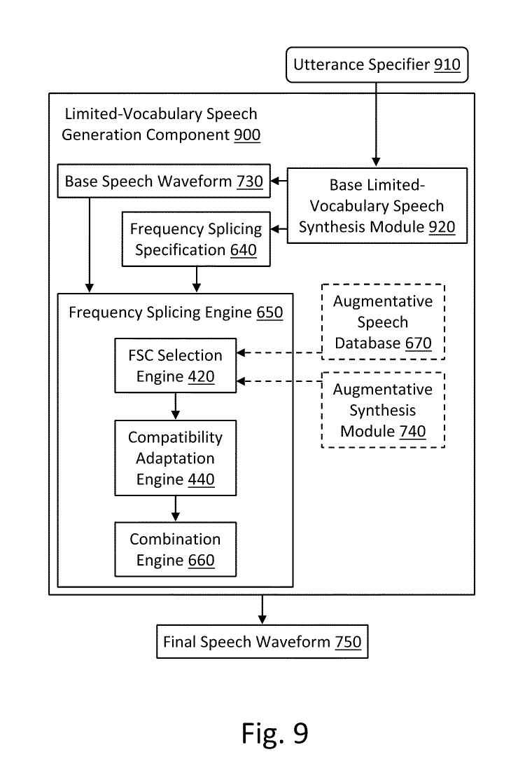

In still another embodiment, the speech synthesis system 150 may be a limited-vocabulary speech synthesis system that generates a base speech waveform 730 which includes one or more base speech segments that will serve as base FSCs 735. In such an embodiment, a separate linguistic analysis component may not be required. FIG. 9 is a schematic block diagram of an example limited-vocabulary speech generation component 900 that employs frequency splicing. The speech generation component 900 receives an utterance specifier 910, which identifies a target utterance from among the limited set of utterances the component 900 is capable of producing. The utterance specifier 910 is passed to a base limited-vocabulary speech synthesis module 920. The base limited-vocabulary speech synthesis module 920 creates a base speech waveform 730 one or more portions of which will serve as base FSCs 735. In addition, the module 920 may generate a frequency splicing specification 640 that may include information descriptive of any absent frequency components in the base FSCs 735. The information may include, for example, indications of base speech segments that should be augmented (i.e., considered as base FSCs 735), as well as indications of the type of augmentation required.

The base speech waveform 730 containing base FSCs 735 is passed to a frequency splicing engine 650. The frequency splicing engine 650 may include an FSC selection engine 420, a compatibility adaptation engine 440, and a combination engine 660. Depending on the particular implementation, best-available or compatible augmentative FSCs may be obtained from a speech database 670, from an augmentative synthesis module 740, or from some different source, or from a combination of sources. The compatibility adaptation engine 440 adapts the augmentative FSCs if necessary. The combination engine 660 adds compatible augmentative FSCs 745 to base FSCs 735 of the base speech waveform 730 to produce a final speech waveform 750, which may be played audibly or stored, as desired.

An example sequence of steps for supplementing limited-vocabulary speech generation with frequency splicing is substantially similar to that shown in FIG. 7B.

Applications of Frequency Splicing

A speech synthesis system 150 built according to the above teachings, be it RBSS, CSS, HSS, or limited-vocabulary, may achieve certain advantages through applications of frequency splicing techniques.

In a first example application, the naturalness of a syllable nucleus generated by RBSS synthesis may be improved. As discussed above, while RBSS systems may be intelligible, they typically sound non-human. To a large extent, the unnatural quality of such systems stems from their rendition of syllable nuclei—in particular, stressed nuclei, which have proven particularly difficult to make natural-sounding using current speech synthesizers. A more natural rendition of a syllable nucleus may be produced for some voices through frequency splicing by synthesizing certain lower formants (e.g., the lower three formants) using RBSS and augmenting these with higher formants (e.g., the higher three formants) derived from a speech database containing human speech. Typically, the lower formants of a syllable nucleus vary the most from nucleus to nucleus and from context to context, while the higher formants are less variable, and small variations are not perceptually important. Since the higher formant frequencies are relatively constant across syllable nuclei in many contexts, a minimal set of augmentative stored speech waveforms may be used for a large number of syllable nuclei.

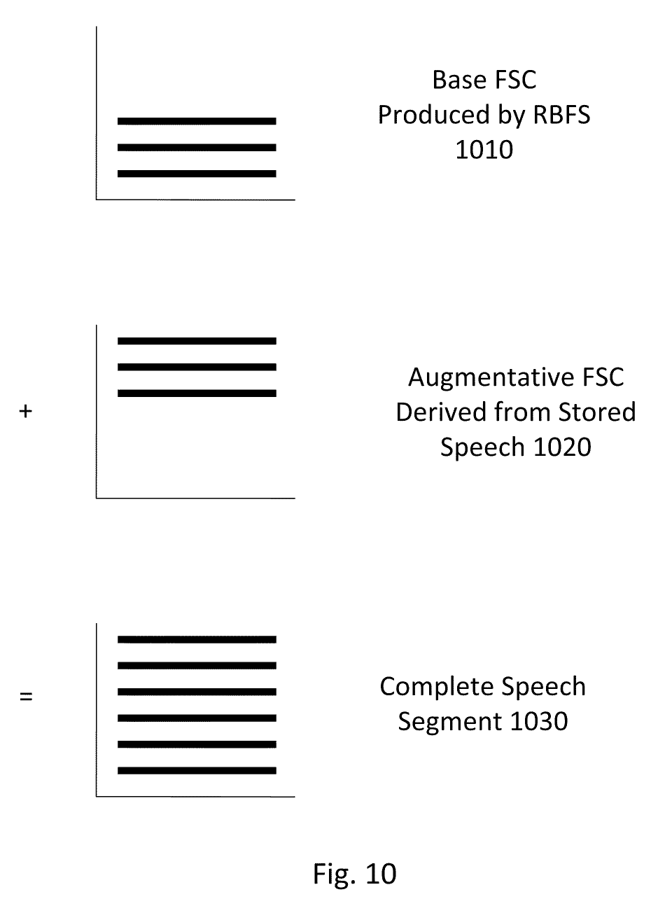

FIG. 10 is a set of example spectrograms that illustrates frequency splicing of a base FSC 1010 representing an RBSS produced vowel with an augmentative FSC 1020 derived from stored speech to produce a complete vowel speech segment 1030. In this example, the first three formants of the vowel are synthesized by RBSS, and, more specifically, by RBFS, to produce the base FSC 1010. The augmentative FSC 1020 may embody the fourth through sixth formants and originate from a speech database containing recorded human speech. In one implementation, the base FSC 1010 and the augmentative FSC 1020 with which it is combined have compatible amplitudes, durations, formant frequencies, fundamental frequency contours, and/or other properties. Because the higher-frequency portion of the complete speech segment 1030 comes from a human speaker, the complete speech segment 1030 may sound more natural than a vowel with all formants synthesized, say by RBFS.

While the example in FIG. 10 and others above illustrate the construction of complete speech segments containing six formants, it should be understood that the number of formants present may depend on the sampling rate and on other factors (e.g., properties of the voice being synthesized) in a particular implementation, and thus may vary.

In a second example application, the storage requirements of a system employing concatenative or hybrid speech generation may be reduced without loss of voice quality, by combining base FSCs containing only lower-frequency components with augmentative FSCs containing missing higher-frequency components, where the augmentative FSCs are derived from a human speaker or produced by RBSS. Because the base FSCs contain only lower-frequency components, the speech database units from which they are derived (for example, by upsampling) may be stored at a lower sample rate than would otherwise be possible. As a specific example, suppose that the one or more speech databases 725 utilized by a base CSS module 710 or a base HSS module 720 store only the lower three formants of vowels, with the employed sampling rate correspondingly reduced. At synthesis time, after appropriate upsampling, the base speech waveform 730 is supplemented with augmentative FSCs that contain only the fourth and higher formants.

In an implementation where the augmentative FSCs are obtained from an augmentative synthesis module, a savings in speech storage requirements may be achieved, because augmentative FSCs are generated “on-the-fly” rather than being stored. However, even in an implementation where the augmentative FSCs are obtained from a database of augmentative stored speech 670, a substantial storage savings may still be realized, since, as described above, higher-frequency formants are fairly constant across contexts and between different syllable nuclei, and thus a minimal set of stored augmentative speech segments may be repeatedly reused.

In a third example application, the naturalness of the speech produced by a synthesis system may be increased and/or the storage requirements of the system may be reduced, by combining base FSCs with augmentative FSCs in order to produce consonants. Certain alveolar fricatives and stop bursts (e.g., [s], [z], and [t] and [d] bursts) typically have strong, perceptually-important higher-frequency components. If these higher-frequency components are not included in the speech stored in the speech database 725 of a CSS-based or HSS-based speech synthesis system—for example because the speech in the database has a low sample rate, the band-limited consonants may be up sampled at synthesis time and then augmented with one or more augmentative FSCs in order to restore the higher-frequency components.

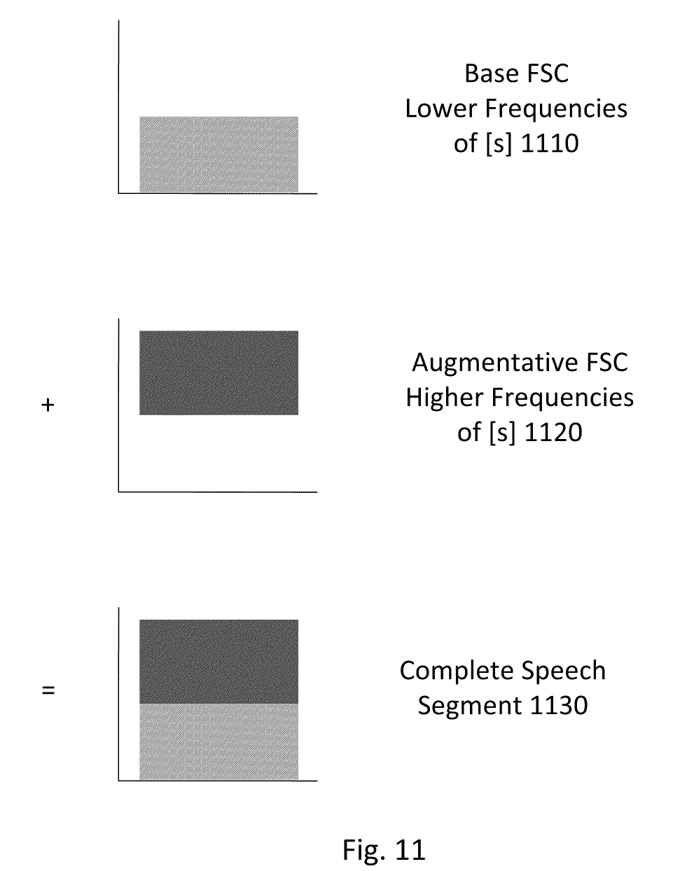

FIG. 11 depicts a set of example spectrograms that illustrates frequency splicing of a band-limited consonant with higher-frequency components. In this example, the base FSC 1110 containing only the lower-frequency components of an [s] is combined with an augmentative FSC 1120 containing the higher-frequency components of an [s] in order to produce a complete speech segment 1130. The base FSC 1110 and the augmentative FSC 1120 may have compatible amplitudes, durations, cutoff frequencies, and/or other properties. The base FSC 1110 may be derived from a speech database 725 of a CSS-based or HSS-based speech synthesis system as described above. The augmentative FSC 1120 may be generated by an augmentative synthesis module, or obtained from an augmentative speech database 670. In the latter case, note that even though the augmentative FSC 1120 is stored, considerable storage savings may be realized by using a small number of stored augmentative FSCs 1120, or even just one, to restore the higher frequencies of base FSCs 1110 derived from many different [s] speech segments stored in the speech database 725.

In a fourth application, frequency splicing may be employed in a speech synthesis system to produce desired voice characteristics. In such an application, a speech segment that lacks a desired voice characteristic is filtered to produce a base FSC which is then combined with an augmentative FSC that imparts to the resulting complete speech segment the desired voice characteristic. As a particular example, frequency splicing may be employed to produce a breathy-sounding vowel from a non-breathy-sounding vowel.

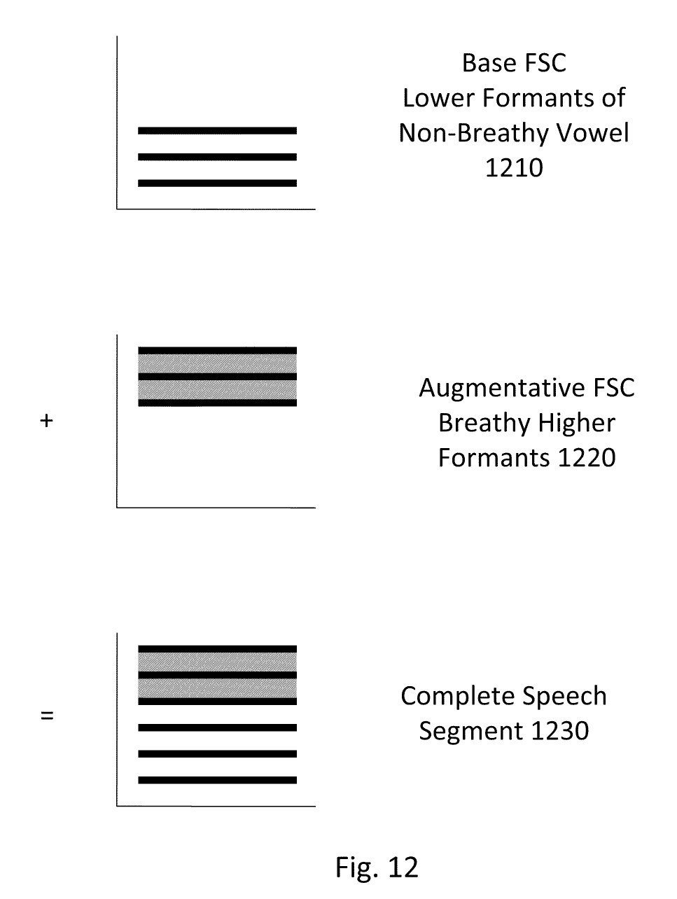

FIG. 12 depicts a set of example spectrograms that illustrates frequency splicing of a base FSC 1210 containing the lower-frequency components of a non-breathy vowel with an augmentative FSC 1220 containing the higher-frequency components of a breathy vowel in order to produce a complete speech segment 1230 for the vowel that sounds breathy. The base FSC 1210 and the augmentative FSC 1220 may have compatible amplitudes, durations, cutoff frequencies, and/or other properties. The augmentative FSC 1220 may be generated by an augmentative synthesis module, or obtained from an augmentative speech database 670.

In a fifth application, frequency splicing may similarly be employed in a speech synthesis system to produce certain contextual variants of speech segments (allophones) from other speech segments. For example, it may be employed to produce nasalized vowels from non-nasalized ones for use in those contexts where the vowel is always nasalized (e.g., before following nasal consonants in the same syllable).

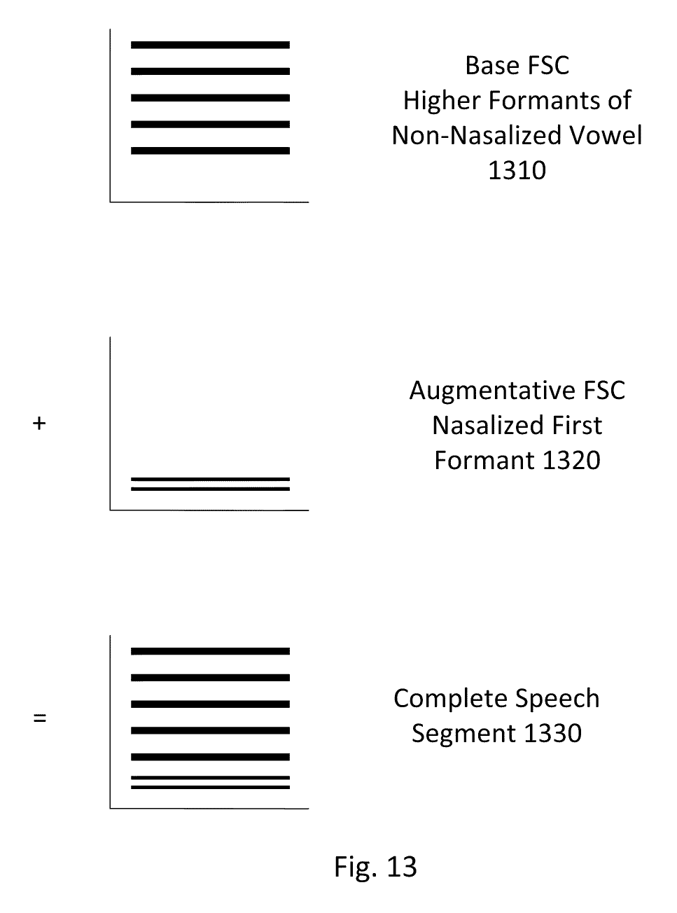

FIG. 13 depicts a set of example spectrograms that illustrates frequency splicing of a base FSC 1310 containing the second and higher formants of a non-nasalized vowel with an augmentative FSC 1320 containing the first formant of a nasalized vowel in order to produce a complete nasalized vowel 1330. The base FSC 1310 and the augmentative FSC 1320 may have compatible amplitudes, durations, cutoff frequencies, and/or other properties. The augmentative FSC 1320 may be synthesized by an augmentative synthesis module 740 to have a split first formant, with two poles and an intervening zero, or other appropriate spectral pattern that creates a nasal vowel percept.

While the example in FIG. 13 shows an augmentative FSC 1320 containing only the first formant, it should be understood that that the cutoff frequency of the high-pass filter may be chosen differently, and other numbers of formants may be supplied in the augmentative FSC 1320.

Use in Telecommunications and Messaging Services

In addition to use in stand-alone speech synthesis systems, the above described frequency splicing techniques may find use in telecommunication systems—for example, telephony systems in which there is a need to transmit intelligible speech sampled at low rates. Both Public Switched Telephone Network (PSTN) and Voice Over Internet Protocol (VOIP) phone calls are commonly sampled at 8,000 hertz, and at this sampling rate the speech is noticeably degraded.

In a frequency splicing application, a transmitting device—such as a plain old telephone service (POTS) telephone or a VOIP telephone—may send a speech waveform having a limited sampling rate—for example, 8,000 samples per second—possibly along with a frequency splicing specification across a transmission link—for example, a link of the PSTN or an Internet link. The frequency splicing specification, if present, may indicate the locations and properties of speech segments requiring augmentation through frequency splicing to produce more intelligible or otherwise improved speech. A receiving device coupled to the transmission medium—for example, another POTS telephone or a VOIP telephone—may upsample the speech waveform to a higher sampling rate, and supplement the waveform with locally stored augmentative FSCs to restore speech quality. The supplementation may be performed in response to the frequency splicing specification, if present, or after an analysis of the waveform to determine which segments to supplement and by what means. The final speech waveform, with a higher sampling rate and broader frequency range than the transmitted waveform, is then used—for example by playing it audibly to a user of the receiving device.

### CONCLUSION

While the above description discusses several embodiments, it should be apparent that further modifications and/or additions may be made without departing from the disclosure's intended spirit and scope. As but one of many possible examples, in some synthesis systems employing frequency splicing, one or more FSSs may be produced by combining two or more FSCs none of which is a base FSC. For example, two or more FSCs selected from a speech database may be modified using compatibility adaptations to be compatible with each other and with the utterance context in which they will occur (with guidance from metadata associated with the base speech segment that they will replace), and then combined. As another example, while the teachings above have described the frequency ranges of FSCs to be chosen primarily with regard to the frequencies of particular formants, it should be remembered that other criteria may be employed, including pre-established cutoff frequencies that are independent of formant frequencies, and others. As a further example, certain decisions made within a synthesis system employing frequency splicing may be the responsibility of one component of the system or another, depending on the particular implementation. As but one example, while some synthesis systems employing frequency splicing may indicate which compatibility adaptations should be applied to an augmentative FSC in the frequency splicing specification (as shown in FIG. 6A), in other systems this decision may be made in the FSC adaptation engine.

In general, it should be remembered that various of the teachings above may be used together or practiced separately. Further, one is reminded that the above-described techniques may be implemented in hardware, for example, in programmable logic devices (PLDs) or application specific integrated circuits (ASICS), in software, in the form of a computer-readable storage medium (such as a CD) having program instructions written thereon for execution on one or more processors, or in a combination thereof. Accordingly, it is the object of the appended claims to cover all such variations and modifications as come within the true spirit and scope of the invention.

What is claimed is:

1. A method for synthesizing speech using a speech synthesis system operating on a computing device that includes at least a processing unit and a memory, the method comprising:
generating a sequence of base speech segments that represent portions of a target utterance, at least some of the base speech segments being generated as, or filtered to become, spectrally incomplete speech segments and thereby considered base frequency splicing components (FSCs);
selecting one or more spectrally incomplete augmentative FSCs;
combining each base FSC of the sequence of base speech segments with one or more augmentative FSCs that at least substantially overlay the base FSC in time, but that have spectral energy that occupies a frequency range that is substantially disjoint from that of the base FSC, the combining to produce a sequence of complete speech segments;
concatenating together the complete speech segments of the sequence of complete speech segments; and
outputting a final speech waveform for the target utterance, wherein the final speech waveform is stored, or played audibly, or both.

2. The method of claim 1 wherein the generating is performed by rule-based speech synthesis (RBSS) and the augmentative FSCs are speech segments that have been derived from a human speaker.

3. The method of claim 1 wherein the selecting further comprises accessing a speech database of stored speech and selecting therefrom speech segments that have been stored as, or may be filtered to become, the augmentative FSCs.

4. The method of claim 1 wherein the base FSCs and augmentative FSCs are waveforms.

5. The method of claim 1 wherein the base FSCs and augmentative FSCs are parametric representations from which waveforms can be derived, and the combining combines a parametric representation of each base FSC with a parametric representation of the one or more augmentative FSCs to produce a parametric representation of the complete speech segments.

6. The method of claim 1 further comprising:
generating a frequency splicing specification which includes information indicating which base speech segments are to be considered as base FSCs and indicating types of augmentation required for the base FSCs,
wherein the selecting one or more spectrally incomplete augmentative FSCs is in response to the frequency splicing specification.

7. The method of claim 1 further comprising:
applying one or more compatibility adaptations to at least some speech segments to produce compatible FSCs to be used in combining with base FSCs.

8. The method of claim 7 wherein the one or more compatibility adaptations comprise one or more operations selected from the group consisting of: amplitude modification, fundamental frequency modification, removal of an initial portion of a speech segment, removal of a final portion a speech segment, time scale modification.

9. The method of claim 1 wherein at least one of the augmentative FSCs is derived from a speech segment having differing linguistic properties, acoustic properties, or both, than those of the base FSC with which the augmentative FSC is combined.

10. The method of claim 1 wherein at least one of the augmentative FSCs is derived from a speech segment taken from a differing linguistic context, acoustic context, or both, than that of the base FSC with which the augmentative FSC is combined.

11. The method of claim 1 wherein at least some of the augmentative FSCs are derived from a differing speaker than the base FSCs with which they are combined.

12. The method of claim 1 wherein the generating generates speech segments for at least some vowels to include only certain selected formants, and the at least some vowels are considered to be base FSCs, and the combining combines the base FSCs corresponding to the at least some vowels with one or more augmentative FSCs that include certain other selected formants.

13. An apparatus for synthesizing speech comprising:
a processing unit; and
a memory configured to store executable instruction code for a speech synthesis system, the executable instruction code for execution on the processing unit, the executable instruction code including code for:
a base synthesis module operable to generate a sequence of base speech segments that represent portions of a target utterance, at least some of the base speech segments being generated as, or filtered to become, spectrally incomplete speech segments and thereby considered base frequency splicing components (FSCs);
a frequency splicing engine having an FSC selection engine operable to select one or more spectrally incomplete augmentative FSCs, and operable to combine each base FSC of the sequence of base speech segments with one or more augmentative FSCs that at least substantially overlay the base FSC in time, but have spectral energy that occupies a frequency range that is substantially disjoint from that of the base FSC, to produce a sequence of complete speech segments, and
a concatenation engine operable to concatenate together the complete speech segments of the sequence of complete speech segments.

14. The apparatus of claim 13 wherein the base synthesis module is a rule-based speech synthesis (RBSS) module, and the frequency splicing engine is operable to access a speech database of stored speech and select therefrom speech segments that have been stored as, or may be filtered to become, the spectrally incomplete augmentative FSCs.

15. A method for synthesizing speech using a speech synthesis system operating on a computing device that includes at least a processing unit and a memory, the method comprising:
constructing a base speech waveform that represents a target utterance, at least some portions of the base speech waveform generated as, or filtered to be, spectrally incomplete and thereby considered base frequency splicing components (FSCs);
obtaining one or more spectrally incomplete augmentative FSCs corresponding to each base FSC of the base speech waveform, the one or more augmentative FSCs having spectral energy that occupies a frequency range that is substantially disjoint from that of the base FSC;
combining each base FSC with the corresponding one or more augmentative FSCs by substantially overlaying the base FSC and the augmentative FSC in time to produce a final speech waveform; and
outputting the final speech waveform to be stored, or played audibly, or both.

16. The method of claim 15 wherein the constructing employs concatenative speech synthesis (CSS) or hybrid speech synthesis (HSS) to produce the base speech waveform.

17. The method of claim 15 wherein the obtaining one or more spectrally incomplete augmentative FSCs comprises:
generating the one or more augmentative FSCs by rule-based speech synthesis (RBSS).

18. The method of claim 15 wherein the obtaining one or more spectrally incomplete augmentative FSCs comprises:
accessing a speech database of stored speech and selecting therefrom speech segments that have been stored as, or may be filtered to become, the augmentative FSCs.

19. The method of claim 15 wherein the constructing a base speech waveform involves concatenating speech waveforms along concatenation boundaries, and wherein frequency splicing boundaries corresponding to the edges of FSCs do not align with the concatenation boundaries.

20. The method of claim 15 further comprising:
generating a frequency splicing specification which includes information indicating portions of the base speech waveform to be considered base FSCs and indicating types of augmentation required for the base FSCs,
wherein the obtaining one or more augmentative FSCs is in response to the frequency splicing specification.

21. The method of claim 15 further comprising:
applying one or more compatibility adaptations to at least some speech segments to produce compatible FSCs to be combined with the base FSCs.

22. The method of claim 15 wherein at least one of the augmentative FSCs is derived from a speech segment having differing linguistic properties, acoustic properties, or both, than those of the base FSC with which the augmentative FSC is combined.

23. The method of claim 15 wherein at least one of the augmentative FSCs is derived from a speech segment taken from a differing linguistic context, acoustic context, or both, than that of the base FSC with which the augmentative FSC is combined.

24. The method of claim 15 wherein at least some of the augmentative FSCs are derived from a differing speaker than the base FSCs with which they are combined.

25. The method of claim 15 wherein the constructing comprises:
generating or filtering at least some vowels to include only certain selected formants and considering the at least some vowels to be base FSCs,
wherein the combining combines each base FSC corresponding to the at least some vowels with one or more augmentative FSCs that include certain other formants.

26. The method of claim 15 wherein the constructing comprises:
generating or filtering at least some consonants to include only certain selected frequency components and considering the at least some consonants to be base FSCs,
wherein the combining combines each base FSC corresponding to the at least some consonants with one or more augmentative FSCs that include certain other frequency components.

27. The method of claim 15 wherein the constructing comprises:
generating or filtering at least some speech segments representing contextual variants of speech segments to include only a predetermined range of frequency components, and considering the at least some speech segments to be base FSCs,
wherein the combining combines each base FSC corresponding to the at least some speech segments with one or more augmentative FSCs representing a different contextual variant.

28. An apparatus for synthesizing speech comprising:
a processing unit; and
a memory configured to store executable instruction code for a speech synthesis system, the executable instruction code for execution on the processing unit, the executable instruction code including code for:
a module operable to construct a base speech waveform that represents a target utterance, at least some portions of the base speech waveform generated as, or filtered to, be spectrally incomplete and thereby considered base frequency splicing components (FSCs);
a frequency splicing engine having an FSC selection engine operable to obtain one or more spectrally incomplete augmentative FSCs corresponding to each base FSC of the base speech waveform, the one or more augmentative FSCs having spectral energy that occupies a frequency range that is substantially disjoint from that of the base FSC, and to combine each base FSC with the corresponding one or more augmentative FSCs by substantially overlaying the base FSC and the augmentative FSC in time to produce a final speech waveform.

29. The apparatus of claim 28 wherein the module is at least one of a concatenative speech synthesis (CSS) module and a hybrid speech synthesis (HSS) module.

30. The apparatus of claim 28 further comprising:
an augmentative rule-based speech synthesis (RBSS) module operable to generate the one or more augmentative FSCs.
